(19) United States
(12) Patent Application Publication
(10) Pub. No.: US 2020/0015326 A1
(43) Pub. Date: Jan. 9, 2020

(54) Heatable Textile Device

(71) Applicant: Gustav Gerster GmbH & Co. KG, Biberach (DE)

(72) Inventor: Martin Gerster, Biberach (DE)

(21) Appl. No.: 16/504,708

(22) Filed: Jul. 8, 2019

(30) Foreign Application Priority Data
Jul. 6, 2018 (DE) 10 2018 116 474.2

(51) Int. Cl. H05B 3/34; H05B 3/00

(52) U.S. Cl. CPC H05B 3/345; H05B 3/347; H05B 2203/009; H05B 3/0004; H05B 2203/005; H05B 3/0019

(57) ABSTRACT

In a textile device (100) having a flexible textile main structure (110) which is made up of textile threads (101) and which has a top surface (111) and a bottom surface (112), temperature metering independent of ambient conditions is achieved in that the main structure (110) is equipped with at least one electrically conductive heating thread (120) which is connected to a first voltage source and with at least one electrically conductive sensor thread (130) which is connected to a second voltage source and which serves for sensing a temperature or a dampness of the main structure (110), wherein a control circuit which is electrically connected to at least one sensor thread (130) is provided for controlling the intensity of a current flow through the heating threads (120) in response to a measured temperature or dampness in order, for every measured actual value, to introduce a predetermined setpoint value of heat into the main structure (110).

### CROSS REFERENCE TO RELATED APPLICATION

Priority is claimed of German patent application DE102018116474.2, filed Jul. 6, 2018, the disclosure of which is incorporated by reference herein in its entirety as if set forth at length.

### BACKGROUND

The invention relates to a textile devices having a flexible textile main structure which is made up of textile threads and which has a top surface and a bottom surface.

Textile devices of the type mentioned in the introduction are used in the prior art for a wide variety of purposes in a wide variety of fields of use. The known textile devices however have the disadvantage that they cannot be set to a predetermined temperature in automated or autonomous reaction to different outside temperatures and different air humidities. Such independence of the temperature of a textile from the meteorological ambient conditions is however necessary or at least advantageous and expedient in many fields of use.

### SUMMARY OF THE INVENTION

The problem addressed by the invention is therefore that of creating a textile device which can be set to a predetermined temperature in automated or autonomous reaction to different outside temperatures and different air humidities.

For a textile device of the type mentioned in the introduction, said object is achieved according to the invention in that the main structure is equipped with at least one electrically conductive heating thread which is connected to a first voltage source and with at least one electrically conductive sensor thread which is connected to a second voltage source and which serves for sensing a temperature or a dampness of the main structure, wherein a control circuit which is electrically connected to at least one sensor thread is provided for controlling the intensity of a current flow through the at least one heating thread in response to a measured temperature or dampness in order, for every measured actual value, to introduce a predetermined setpoint value of heat into the main structure.

Preferred embodiments of the invention are the subject of the subclaims, the elements of which serve to further improve the approach to a solution to the problem addressed by the invention.

In the case of the textile device according to the invention, by means of the combination of features whereby the main structure is equipped with at least one electrically conductive heating thread which is connected to a first voltage source and with at least one electrically conductive sensor thread which is connected to a second voltage source and which serves for sensing a temperature or a dampness of the main structure, wherein a control circuit which is electrically connected to at least one sensor thread is provided for controlling the intensity of a current flow through the at least one heating thread in response to a measured temperature or dampness in order, for every measured actual value, to introduce a predetermined setpoint value of heat into the main structure, independence of a textile from locally present meteorological environmental conditions, or open-loop and/or closed-loop controllability of the temperature of a textile in view of changing meteorological or locally present environmental conditions, such as a change in the ambient temperature or change in the ambient air humidity, is achieved. In this respect, for the textile device according to the invention, temperature metering independent of changing ambient conditions is made possible.

According to a first preferred embodiment of the textile device according to the invention, provision is made for the main structure to be equipped both with a sensor thread for sensing a temperature of the main structure and with a sensor thread for sensing a dampness of the main structure.

Here, the at least one heating thread and the at least one sensor thread may be attached in the region of the same top or bottom surface of the main structure, or the at least one heating thread may be attached in the region of the top surface of the main structure and the at least one sensor thread may be attached in the region of the bottom surface of the main structure.

According to an important preferred embodiment of the textile device according to the invention, the control circuit is configured to control the intensity of a current flow through the heating threads in response to a measured temperature or dampness in order, for every measured actual value, to introduce into the main structure a predetermined setpoint value of heat in order to bring the main structure to an always identical predetermined temperature.

Here, the control circuit is preferably configured to, in the case of a sensor thread which exhibits a non-linear measurement curve in the presence of a linear temperature increase or a linear dampness increase, control an intensity of the current flowing through the at least one heating thread in order to generate such an introduction of heat in the main structure that the temperature of the main structure is always constant irrespective of the measured temperature or dampness.

According to an alternative important preferred embodiment of the textile device according to the invention, the control circuit is configured to control the intensity of a current flow through the heating threads in response to a measured temperature or dampness in order, for every measured actual value, to introduce into the main structure a predetermined setpoint value of heat in order to bring the main structure to a temperature assigned to a respective measured temperature or dampness.

Here, the control circuit is preferably configured to, in the case of a sensor thread which exhibits a non-linear measurement curve in the presence of a linear temperature increase or a linear dampness increase, control an intensity of the current flowing through the at least one heating thread in order to generate such an introduction of heat in the main structure that the temperature of the main structure increases linearly with a linearly decreasing measured temperature or dampness.

In the textile device according to the invention, a heating thread is typically formed by a carbon thread, wherein, as a heating thread, use may however also be made of a conventional electrical resistance wire or in particular also of a textile thread with electrically conductive coating.

Furthermore, depending on the usage situation, a temperature sensor thread may be formed by a thermistor with a negative temperature coefficient (NTC resistor) or by a thermistor with a positive temperature coefficient (PTC resistor).

A dampness sensor thread preferably comprises a hydrophilic conductive material, the conductivity of which changes with the quantity of absorbed water molecules.

The main structure of the textile device according to the invention may for example be formed by a woven fabric, laid scrim, warp-knitted fabric, weft-knitted fabric, an embroidered fabric, a nonwoven or a film, wherein both the heating threads and the sensor threads are woven, laid, warp-knitted, weft-knitted, embroidered or introduced or applied in some other way into the main structure.

According to a further preferred embodiment of the textile device according to the invention, a heating thread introduced into the main structure is configured to run in meandering fashion in order to cover as large a surface area of the main structure as possible.

Here, a heating thread introduced into the main structure preferably forms a closed loop with two adjacently arranged ends, wherein a first end is to be connected to a first terminal of the first voltage source and a second end is to be connected to the second terminal of the first voltage source. In this way, easy coupling to a voltage source, which has generally adjacently arranged electrical terminals, is ensured.

Furthermore, the loop of the heating thread may be introduced into the main structure so as to run in meandering fashion such that a first loop part, which leads from the first end of the heating thread to a reversal point of the heating thread, is laid parallel, with a predefined spacing, with respect to a second loop part, which leads from the reversal point to the second end of the heating thread.

In accordance with a very special arrangement, the loop of the heating thread is introduced into the main structure so as to run partially in meandering fashion such that a first loop part, which leads from the first end of the heating thread to a reversal point of the heating thread, is introduced into the main structure in meandering fashion parallel, with a predefined spacing, with respect to the loop form of the sensor thread laid in meandering fashion, and a second loop part, which leads from the reversal point to the second end of the heating thread, is introduced into the main structure so as to run rectilinearly. An advantage of this arrangement lies in highly effective large-area coverage of the surface of a main structure.

According to a further preferred embodiment of the textile device according to the invention, a sensor thread introduced into the main structure is also configured to run in meandering fashion in order to cover as large a surface area of the main structure as possible.

Here, a sensor thread introduced into the main structure preferably forms a closed loop with two adjacently arranged ends, wherein a first end is to be connected to a first terminal of the first voltage source and a second end is to be connected to the second terminal of the first voltage source.

Furthermore, the loop of the sensor thread may be introduced into the main structure so as to run in meandering fashion such that a first loop part, which leads from the first end of the sensor thread to a reversal point of the sensor thread, is laid parallel, with a predefined spacing, with respect to a second loop part, which leads from the reversal point to the second end of the sensor thread.

In accordance with a very special arrangement, the loop of the sensor thread is introduced into the main structure so as to run partially in meandering fashion such that a first loop part, which leads from the first end of the sensor thread to a reversal point of the sensor thread, is introduced into the main structure in meandering fashion parallel, with a predefined spacing, with respect to the loop form of the heating thread laid in meandering fashion, and a second loop part, which leads from the reversal point to the second end of the sensor thread, is introduced into the main structure so as to run rectilinearly. An advantage of this arrangement likewise lies in highly effective large-area coverage of the surface of a main structure.

### BRIEF DESCRIPTION OF THE DRAWINGS

The textile device according to the invention will be discussed below on the basis of two preferred embodiments, which are illustrated in the figures of the drawings, in which:

FIG. 1 shows a first preferred embodiment of the textile device according to the invention in a view from above;

FIG. 2 shows a second preferred embodiment of the textile device according to the invention in a view obliquely from above.

### DETAILED DESCRIPTION

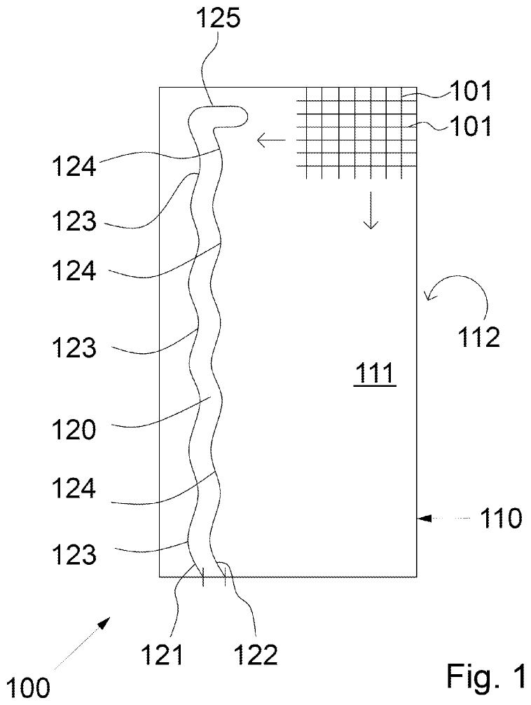

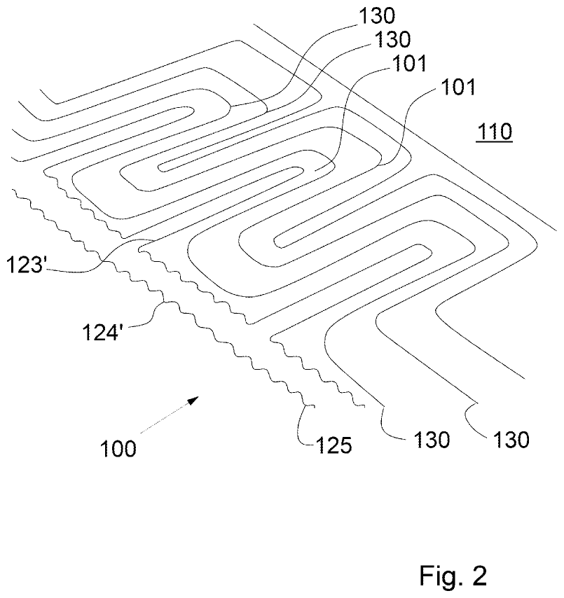

The textile device 100 according to the invention illustrated in FIGS. 1 and 2 comprises a flexible textile main structure 110 which is made up of textile threads 101 and which has a top surface 111 and a bottom surface 112, wherein the main structure 110 is equipped with at least one electrically conductive heating thread 120 which is connected to a first voltage source and with an electrically conductive sensor thread 130 which is connected to a second voltage source and which serves for sensing a temperature of the main structure 110.

Here, a control circuit which is electrically connected to at least one sensor thread 130 is provided for controlling the intensity of a current flow through the heating threads 120 in response to a measured temperature or dampness in order, for every measured actual value, to introduce a predetermined setpoint value of heat into the main structure 110.

The heating thread 120 and the sensor thread 130 are attached in the region of the same surface 111 of the main structure 110.

The control circuit is configured to control the intensity of a current flow through the heating threads 120 in response to a measured temperature or dampness in order, for every measured actual value, to introduce into the main structure 110 a predetermined setpoint value of heat in order to bring the main structure 110 to an always identical predetermined temperature.

The control circuit is furthermore configured to, in the case of a sensor thread 130 which exhibits a non-linear measurement curve in the presence of a linear temperature increase or a linear dampness increase, control an intensity of the current flowing through the at least one heating thread 120 in order to generate such an introduction of heat in the main structure 110 that the temperature of the main structure 110 is always constant irrespective of the measured temperature or dampness.

A heating thread 120 of the textile device 100 according to the invention is formed by a carbon thread.

A temperature sensor thread 130 is formed by a thermistor with a positive temperature coefficient (PTC resistor).

The main structure 110 is formed by a woven fabric, and both the heating thread 120 and the sensor thread 130 are woven into the main structure 110.

A heating thread 120 introduced into the main structure 110 is configured to run in meandering fashion in order to cover as large a surface area of the main structure 110 as possible.

Here, the heating thread 120 introduced into the main structure 110 forms a closed loop with two adjacently arranged ends 121, 122, wherein a first end 121 is to be connected to a first terminal of the first voltage source and a second end 122 is to be connected to the second terminal of the first voltage source.

In the embodiment illustrated in FIG. 1, the loop of the heating thread is introduced into the main structure 110 so as to run in meandering fashion such that a first loop part 123, which leads from the first end 121 of the heating thread 120 to a reversal point 125 of the heating thread 120, is laid parallel, with a predefined spacing, with respect to a second loop part 124, which leads from the reversal point 125 to the second end 122 of the heating thread 120.

According to the embodiment illustrated in FIG. 2, the loop of the heating thread 120 is introduced into the main structure 110 so as to run partially in meandering fashion such that a first loop part 123′, which leads from the first end 121 of the heating thread 120 to a reversal point 125 of the heating thread 120, is introduced into the main structure 110 in meandering fashion parallel, with a predefined spacing, with respect to the loop form of the sensor thread 130 laid in meandering fashion, and a second loop part 124′, which leads from the reversal point 125 to the second end 122 of the heating thread 120, is introduced into the main structure 110 so as to run rectilinearly.

The exemplary embodiments of the invention discussed above serve merely for the purposes of improved understanding of the teaching according to the invention as predefined by the claims, which as such is not restricted by the exemplary embodiments.

### LIST OF REFERENCE DESIGNATIONS

The following is a list of reference numerals:

100 Textile device

101 Textile threads

110 Main structure

111 Top surface

112 Bottom surface

120 Heating thread

130 Sensor thread

121 First end

122 Second end

123 First loop part

124 Second loop part

123′ First loop part

124′ Second loop part

125 Reversal point

What is claimed is:

1. A textile device (100) having a flexible textile main structure (110) which is made up of textile threads (101) and which has a top surface (111) and a bottom surface (112), wherein:
the main structure (110) is equipped with at least one electrically conductive heating thread (120) which is connected to a first voltage source and with at least one electrically conductive sensor thread (130) which is connected to a second voltage source and which serves for sensing a temperature or a dampness of the main structure (110); and
a control circuit which is electrically connected to the at least one sensor thread (130) is provided for controlling the intensity of a current flow through the at least one heating thread (120) in response to a measured temperature or dampness in order, for every measured actual value, to introduce a predetermined setpoint value of heat into the main structure.

2. The textile device (100) of claim 1, wherein the main structure (110) is equipped both with a sensor thread (130) for sensing a temperature of the main structure (110) and with a sensor thread (130) for sensing a dampness of the main structure (110).

3. The textile device (100) of claim 1, wherein the at least one heating thread (120) and the at least one sensor thread (130) are attached in the region of the same top (111) or bottom surface (112) of the main structure (110).

4. The textile device (100) of claim 1, wherein the at least one heating thread (120) is attached in the region of the top surface (111) of the main structure (110) and the at least one sensor thread (130) is attached in the region of the bottom surface (112) of the main structure (110).

5. The textile device (100) of claim 1, wherein the control circuit is configured to control the intensity of a current flow through the at least one heating thread (120) in response to a measured temperature or dampness in order, for every measured actual value, to introduce into the main structure (110) a predetermined setpoint value of heat in order to bring the main structure (110) to an always identical predetermined temperature.

6. The textile device (100) of claim 1, wherein the control circuit is configured to, in the case of a sensor thread (130) which exhibits a non-linear measurement curve in the presence of a linear temperature increase or a linear dampness increase, control an intensity of the current flowing through the at least one heating thread (120) in order to generate such an introduction of heat in the main structure (110) that the temperature of the main structure (110) is always constant irrespective of the measured temperature or dampness.

7. The textile device (100) of claim 1, wherein the control circuit is configured to control the intensity of a current flow through the at least one heating thread (120) in response to a measured temperature or dampness in order, for every measured actual value, to introduce into the main structure (110) a predetermined setpoint value of heat in order to bring the main structure (110) to a temperature assigned to a respective measured temperature or dampness.

8. The textile device (100) of claim 7, wherein the control circuit is configured to, in the case of a sensor thread (130) which exhibits a non-linear measurement curve in the presence of a linear temperature increase or a linear dampness increase, control an intensity of the current flowing through the at least one heating thread (120) in order to generate such an introduction of heat in the main structure (110) that the temperature of the main structure (110) increases linearly with a linearly decreasing measured temperature or dampness.

9. The textile device (100) of claim 1, wherein the heating thread (120) is formed by a carbon thread.

10. The textile device (100) of claim 1, wherein the heating thread (120) is formed by a conventional electrical resistance wire.

11. The textile device (100) of claim 1, wherein the heating thread (120) is formed by a textile thread with electrically conductive coating.

12. The textile device (100) of claim 1, wherein a temperature sensor thread (130) of the at least one sensor thread (130) is formed by a thermistor with a negative temperature coefficient (NTC resistor).

13. The textile device (100) of claim 1, wherein a temperature sensor thread (130) of the at least one sensor thread (130)is formed by a thermistor with a positive temperature coefficient (PTC resistor).

14. The textile device (100) of claim 1, wherein a dampness sensor thread (130) of the at least one sensor thread (130) comprises a hydrophilic conductive material, the conductivity of which changes with the quantity of absorbed water molecules.

15. The textile device (100) of claim 1, wherein the main structure (110) is formed by a woven fabric, laid scrim, warp-knitted fabric, weft-knitted fabric, an embroidered fabric, a nonwoven or a film, and both the heating threads (120) and the sensor threads (130) are woven, laid, warp-knitted, weft-knitted, embroidered or introduced or applied in some other way into the main structure (110).
